(19) United States
(12) Patent Application Publication
(10) Pub. No.: US 2026/0043350 A1
(43) Pub. Date: Feb. 12, 2026

(54) SYSTEMS, METHODS, AND APPARATUS FOR FUEL SUPPLY AND INJECTION

(71) Applicant: North American Wave Engine Corporation, Baltimore, MD (US)

(72) Inventor: Daanish MAQBOOL, North Bethesda, MD (US)

(21) Appl. No.: 19/292,519

(22) Filed: Aug. 6, 2025

Related U.S. Application Data
(60) Provisional application No. 63/680,016, filed on Aug. 6, 2024.

(51) Int. Cl. F02C 7/22; F02K 7/02

(52) U.S. Cl. CPC F02C 7/222; F02K 7/02

(57) ABSTRACT

A system and method are disclosed for improving fuel-air mixing in the combustion chamber of pulse combustors by deflecting the pressurized fuel injected from the one or more fuel injectors at a predetermined angle towards the centerline longitudinal axis of the combustion chamber.

### CROSS-REFERENCE TO RELATED APPLICATIONS

This application claims priority to U.S. Provisional Application No. 63/680,016, filed Aug. 6, 2024.

### TECHNICAL FIELD

The present disclosure relates generally to fuel supply and injection systems and methods for jet engines.

### BACKGROUND

A valveless-type combustor or pulsejet engine can include a combustion chamber, an inlet pipe, fuel injector(s), a spark plug (or other ignition device), and an exhaust pipe, which is sometimes referred to as a “tailpipe”. These pulsejet engines can be configured straight or U-shaped. The combustion chamber, inlet pipe and exhaust are often cylindrical. In many pulsejet engines, the diameters of the inlet and exhaust pipes are less than the diameter of the combustion chamber. Further, the length of the inlet pipe is less than the length of the exhaust pipe.

When a fuel and air mixture is introduced into the combustion chamber, the spark plug or other ignition device is activated to produce a high-temperature source that ignites the fuel/air mixture. The ensuing combustion process causes a rise in the temperature and pressure of the gases inside the combustion chamber. These gases then rapidly expand and escape through the inlet and exhaust pipes. The high velocity of the escaping gases causes an overexpansion and negative pressure inside the combustion chamber. This negative pressure reverses the direction of the flow in the inlet and exhaust pipes. Fresh air sucked in from the atmosphere via the inlet pipe reaches the combustion chamber because of its shorter length mixes with new fuel that is injected either in the inlet pipe or directly into the combustion chamber the new fuel/air mixture that enters the combustion chamber encounters the high-temperature combustion products from the previous combustion event. These combustion products ignite this new fuel/air mixture to produce another combustion event and the process repeats indefinitely as long as there is fuel being injected into the combustion chamber as described.

In tracking the combustion events, there is also flow reversal in the exhaust pipe due to the negative pressure in the combustion chamber. However, due to the length of the exhaust pipe, the fresh air drawn in from the atmosphere does not typically reach the combustion chamber before the next combustion event. Also, the spark plug is only needed to start operation of the engine, and is not necessary to sustain the operation of the engine. Therefore, the spark plug can be turned off once the engine is started.

The result of the working cycle of a pulse combustor is that the inlet and exhaust ends produce oscillating flows. These flows can result in intermittent jets of gas that emanate from them and are responsible for thrust generation. The exhaust pipe generates the greatest amount of thrust, and the inlet pipe can also generate a significant amount of thrust, which is on the order of two-thirds (⅔) the thrust generated by the exhaust pipe. Therefore, in order to capture the thrust generated by both the inlet and exhaust pipes, both pipes are pointed in the same direction. This is accomplished by the exhaust pipe being bent so that the inlet pipe points in the same direction as the exhaust pipe, giving the engines a “U-shape”.

It is desirable to pulsejet that have improved capabilities in many different aspects, including, but not limited to, improved fuel supply and injection.

### SUMMARY

Pulse combustors can have a number of different forms. Some have multiple inlets, while others have inlets that are perpendicular to the exhaust pipe. However, all of them typically employ the same working principle as described above.

Pulse combustors can draw in fresh air and sustain operation without any external machinery or moving parts. Further, pulse combustors can be used as thrust-producing devices, sometimes referred to as “pulsejet,” “pulse jet,” or “wave” engines. Pulsejet engines have been used to propel several types of aircraft and result in the aircraft having a diverging exhaust pipe to aid in thrust production.

In addition to the main combustor (engine) components described earlier, there are also systems for the supply and injection of fuel into the engine. For example, they include fuel rails, which hold a circulating supply of pressurized fuel for injection into the engine, and electronic fuel injectors, which are long, electrically controlled devices that control pressurized fuel from the fuel rail being injected into an engine. Some fuel injectors have a spring-loaded pintle resting in a hole that is connected to a solenoid. When the solenoid is energized, it lifts the pintle to create an opening between the pintle and the hole that allows pressurized fuel to flow out of the fuel injector and into the engine.

It is advantageous to inject fuel at an angle to the direction of air flow inside the engine (and therefore, at an angle to the engine inlet and/or combustion chamber axes) to facilitate fuel-air mixing. However, installing the fuel injector at an angle to the air flow causes the injector to protrude outward from the engine. Outward protrusion of the fuel injector is undesirable because it increases the physical dimensions of the engine. Furthermore, the outward protrusion of the injectors away from the engine axis also necessitates a larger fuel rail which further increases the physical dimensions of the engine. An increase in the physical dimensions of the engine makes it more complicated to integrate with an airframe and increases drag with forward air speed.

Some embodiments of the present invention are directed to fuel supply and injection methods and systems for pulsejet engine systems that are compact. For example, they will allow for improved engine performance.

In at least one embodiment, the pulsejet engine includes an inlet pipe, combustion chamber, exhaust pipe, spark plug or other ignition device, and a fuel injection assembly which includes fuel injector(s), deflector plates and a circular fuel rail. Fuel injectors are installed along the inlet pipe axis and around the inlet pipe in an axisymmetric fashion, such that they inject fuel into the combustion chamber. Angled deflector plates are installed inside the combustion chamber in the fuel spray path to deflect fuel spray from the fuel injectors towards the combustion chamber centerline. A circular fuel rail is placed behind the injectors (and therefore, around the inlet pipe) to supply pressurized fuel to the injectors. In operation, when the fuel injectors are activated (energized), pressurized fuel is directed from the fuel rail and injected into the combustion chamber. The high-velocity fuel spray then collides with the deflector plates and deflects inward towards the combustion chamber centerline. This arrangement allows for compactness of the overall fuel supply and injection apparatus while providing adequate engine performance.

### BRIEF DESCRIPTION OF THE DRAWINGS

FIG. 1 illustrates a representative side view of a U-shape pulse combustor, according to some embodiments.

FIG. 2 illustrates a representative top left perspective view of a U-shape pulse combustor, according to some embodiments.

FIG. 3 illustrates a representative aft view of a U-shaped pulse combustor, according to some embodiments.

FIG. 4 illustrates a representative prospective view of an embodiment of a fuel deflector insert, according to some embodiments.

FIG. 5 illustrates a representative prospective view of an embodiment of a fuel rail assembly, according to some embodiments.

FIG. 6 illustrates a close-up of a representative side view of a U-shape pulse combustor, according to some embodiments.

FIG. 7 illustrates a close-up of a representative top left perspective view of a U-shape pulse combustor, according to some embodiments.

FIG. 8 illustrates an exploded representative side view, according to some embodiments.

FIG. 9 illustrates an exploded representative top left perspective view, according to some embodiments.

FIG. 10 illustrates a representative perspective view of an embodiment of a nozzle insert, according to some embodiments.

### REFERENCE NUMERALS IN THE DRAWINGS

| Ref. No. | Description |
|---|---|
| 10 | Pulse Combustor |
| 12 | Inlet Pipe |
| 14 | Combustion Chamber |
| 16 | Exhaust Pipe |
| 20 | Fuel Injection Assembly |
| 22 | Fuel Injector(s) |
| 24 | Fuel Rail Bolt |
| 30 | Fuel Deflector Insert |
| 32 | Fuel Deflector Baseplate |
| 34 | Fuel Deflector Standoff |
| 36 | Fuel Deflector Plate |
| 40 | Fuel Rail Assembly |
| 41 | Injector Boss(es) |
| 43 | Fuel Passage |
| 45 | Fuel Flow Port(s) |
| 47 | Measurement Port(s) |
| 49 | Bolt Hole(s) |
| 50 | Nozzle Insert |
| 52 | Nozzle Base |
| 54 | Nozzle Plenum |
| 56 | Nozzle |
| 58 | Fuel Supply Receiver |

### DETAILED DESCRIPTION

The terms “pulse combustor,” “pulse jet engine,” “pulse jet,” “pulsejet engine,” “pulsejet,” or “wave engine” are used synonymously. It is understood that a pulsejet or pulse jet engine is a pulse combustor that is used for thrust production. It is also understood that wave engines are a class or family of engines, within which a type of engine is a pulsejet engine.

Pulse combustors, particularly when used as thrust-producing devices, can be made compact to reduce aerodynamic drag and ease integration with airframes. In some configurations, the fuel supply and injection components of the engine can protrude outward from the combustion chamber and/or inlet pipe and it is desirable to install or package these tightly within the frontal projected perimeter of the combustion chamber to reduce aerodynamic drag and installation complexity.

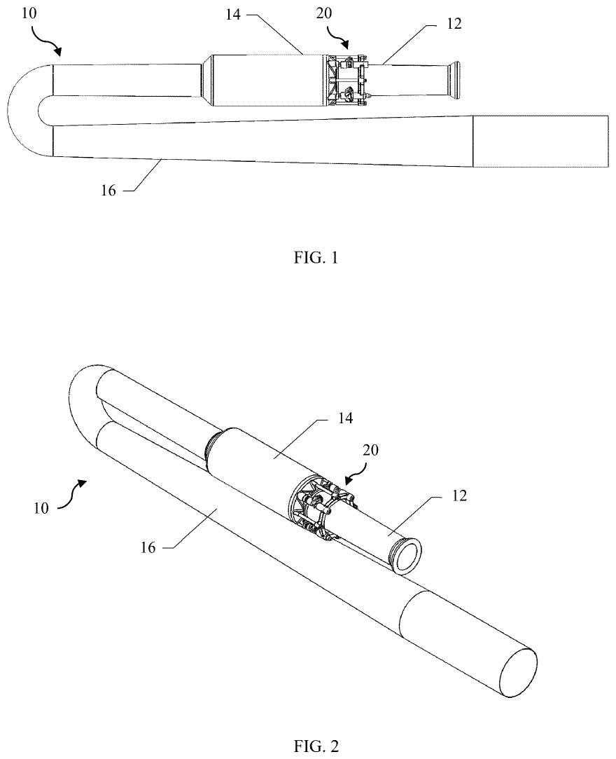

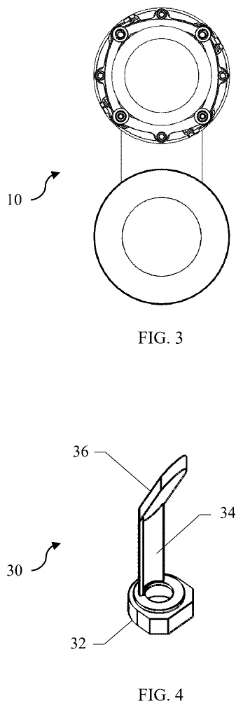

Generally, FIGS. 1, 2, and 3 illustrate representative side, perspective and aft views of a pulse combustor 10 according to an embodiment. The pulse combustor 10 includes an inlet pipe 12 connected to one open end of a combustion chamber 14. The other open end of the combustion chamber 14 is connected to an exhaust pipe 16. The pulse combustor 10 also includes a fuel injection assembly 20 connected to the combustion chamber 14 for supplying and injecting fuel into the combustion chamber 14. Further, the pulse combustor 10 includes a spark plug or other ignition device (not shown in FIGS. 1-3) for igniting the fuel/air mixture in the combustion chamber 14.

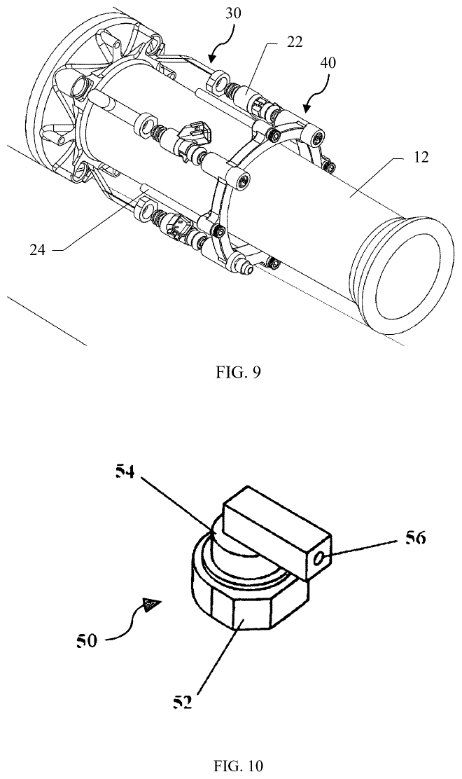

FIG. 4 is a representative perspective view of a fuel deflector insert 30, in accordance with an embodiment. The fuel deflector insert 30 includes a fuel deflector baseplate 32 that has a seat for fuel injector(s) 22 (see FIGS. 8 and 9) and an opening to allow for the fuel spray to pass through. The fuel deflector baseplate 32 is connected to a fuel deflector standoff 34, which is then connected to a fuel deflector plate 36 at an angle nominally between 20 and 90 degrees.

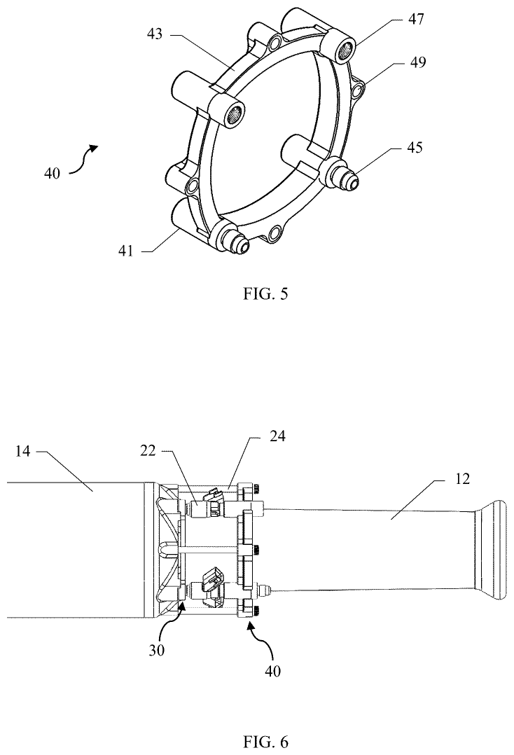

FIG. 5 is a representative perspective view of a fuel rail assembly 40, in accordance with an embodiment. The fuel rail assembly 40 includes injector boss(es) 41 arranged in axisymmetric fashion and connected to one another via a fuel passage 43 that creates a fluidic connection between the injector boss(es) 41 and allows fuel to flow between the injector boss(es) 41. In general, two injector boss(es) are also connected to fuel flow port(s) 45 for fuel intake and exhaust (also known as supply and return as would be known toa person of ordinary skill in the art).

Generally, one fuel flow port 45 is in fluidic connection with a pressurized fuel source and the other fuel flow port 45 is in fluidic connection with a fuel pressure regulator. The fuel passage 43 is internally blocked between fuel flow ports 45 to force the fuel to circulate past all injector boss(es) 41. The injector boss(es) 41 that are not connected to fuel flow ports 45 are connected to measurement port(s) 47, which can be used to install instrumentation for the measurement of fuel properties, such as temperature and pressure.

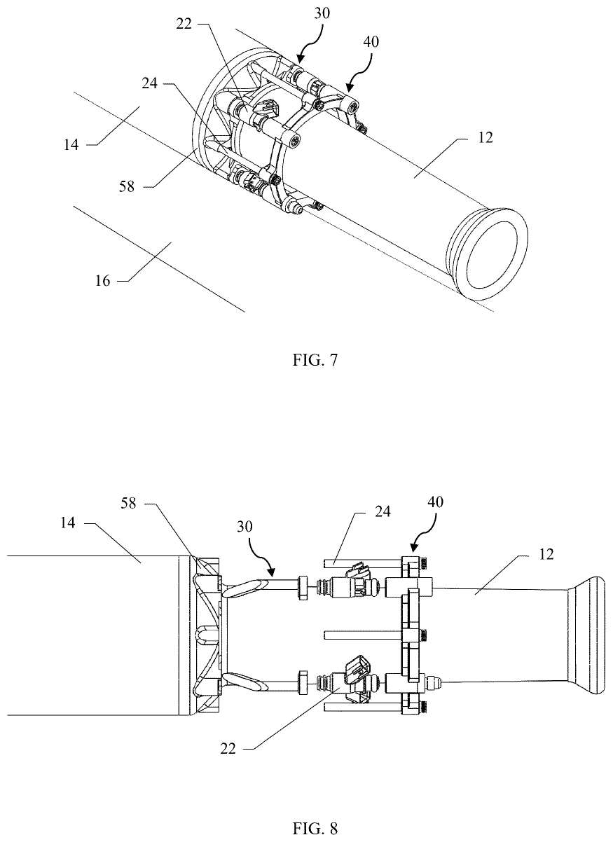

FIGS. 6 and 7 are close-up side and perspective views of the pulse combustor 10, in accordance with an embodiment, to show details of the fuel injection assembly 20 as assembled on the pulse combustor engine. In one embodiment, a fuel supply receiver 58 is disposed around the inlet pipe 12 and fixed to the combustion chamber 14. Optionally, the fuel supply receiver 58 does not extend perpendicularly outward beyond the diameter the end of the combustion chamber 14 to which it is fixed. The fuel supply receiver 58 has one or more fixtures having openings therethrough in fluid communication with the interior of the combustion chamber 14 through the first end of the combustion chamber.

FIGS. 8 and 9 are exploded side and perspective views of the pulse combustor 10, in accordance with an embodiment, to show details of the fuel injection assembly 20. In some examples, one end (the fuel ingress end) of fuel injector(s) 22 is installed into injector boss(es) 41 of the fuel rail assembly 40: The other end (the fuel egress end) of fuel injector(s) 22 is installed in the fuel deflector baseplate 32 of the fuel deflector insert 30, and the fuel deflector insert 30 is installed into the combustion chamber 14. A fuel rail bolt 24 goes through a bolt hole 49 of the fuel rail assembly 40 and threads into the fuel supply receiver 58 to press and hold together the fuel deflector insert 30 and components of the fuel rail assembly 40.

In some implementations, fuel flows from a high pressure source, such as a fuel pump, into a fuel flow port 45. This pressurized fuel then flows around the fuel passage 43 and exits the fuel rail assembly at another fuel flow port 45. The net result is that there is a circulating supply of pressurized fuel inside the fuel passage 43. This provides fuel injector(s) 22 with a constant supply of pressurized fuel via injector boss(es) 41 which are in fluidic connection with the fuel passage 43.

When fuel injector(s) 22 are activated and opened, fuel flows through fuel injector(s) 22 and is sprayed through the opening in fuel deflector baseplate 32 to strike the fuel deflector plate 36 situated inside the combustion chamber. When fuel strikes the fuel deflector plate 36, it is scattered and deflected inward toward the centerline of the combustion chamber, for effective fuel-air mixing and combustion. This allows for a compact fuel injection assembly/apparatus to produce adequate pulse combustor operation.

In other embodiments, which may or may not have been explicitly described above, systems, methods, and apparatus share the same principle of operation as disclosed by present application. For example, the fuel deflector insert 30 and/or the fuel deflector plate 36 can be permanently attached/affixed the interior of the combustion chamber 14 so as to be an integral part of the combustion chamber. A fuel spray is injected into a combustion chamber and then made to strike an angled plate to scatter and deflect it toward the centerline of the combustion chamber. Any alternative physical configurations are part of embodiments of the present invention.

FIG. 10 is a representative perspective view of an embodiment of a nozzle insert 50 that may be used as an alternative to fuel deflector insert 30 shown in FIG. 4. Nozzle insert 50 is connected to an injector and extends into the combustion chamber like fuel deflector insert 30. Nozzle insert 50 has nozzle base 52, nozzle plenum 54, and nozzle 56. As shown, nozzle 56 is preferably oriented at a right angle (90°) to a connected fuel injector so pressurized fuel from the injector is directed towards the centerline of the combustion chamber for fuel-air mixing. Although the nozzle is illustrated for directing pressurized fuel from an injector at 90°, it is understood that the nozzle can be configured to direct the pressurized fuel at other angles and still be within the scope of the present invention.

The described embodiments in the present invention in this Specification are meant to be representative of the use of fuel injectors and deflector plates with a pulsejet engine. However, someone of ordinary skill in the art would understand other embodiments are possible that will be within the scope of the present invention.

What is claimed is:

1. A system for supplying fuel to a pulse combustor having at least a combustion chamber, an inlet pipe connected to a first end of the combustion chamber, an exhaust pipe with a length longer than the inlet pipe connected to a second end of the combustion chamber, an ignition means for igniting combustible mixtures within the combustion chamber, comprising:
a fuel supply receiver disposed around the inlet pipe and fixed to the first end of the combustion chamber with the fuel supply receiver not extending perpendicularly outward beyond a diameter of the first end of the combustion chamber, and with one or more fixtures having openings therethrough in fluid communication with an interior of the combustion chamber through the first end of the combustion chamber; and
a fuel rail assembly disposed around the inlet pipe and in spaced connection to the fuel supply receiver with the fuel rail assembly not extending perpendicularly outward beyond a diameter of the first end of the combustion chamber including
an interior fuel passage through at least a portion of the fuel rail assembly,
two or more hollow fuel injector receivers spaced along, and disposed perpendicular to, the fuel rail assembly, with each hollow fuel injector receiver having a first open end toward, and a second end away from, the fuel supply receiver, and with each hollow fuel injector receiver being in fluid communication with the interior fuel passage,
a fuel injector connected to, and in fluid communication with, the open end of each of the two or more hollow fuel injector receivers,
a fuel deflector means associated with each fuel injector for deflecting fuel from the associated fuel injector in the combustion chamber when the fuel deflector means is disposed into the interior of the combustion chamber,
at least one ingress fuel port connected to the second end of a hollow fuel injection receiver for supplying fuel to the interior fuel passage, and
at least one egress fuel port connected to the second end of a hollow fuel injection receiver for removing fuel from the interior fuel passage.

2. The system as recited in claim 1, wherein the fuel supply receiver includes being circular.

3. The system as recited in claim 2, wherein the diameter of the fuel supply receiver is equal to or less than the diameter of the combustion chamber.

4. The system as recited in claim 1, wherein the fuel rail assembly includes being circular.

5. The system as recited in claim 4, wherein the diameter of the fuel rail assembly is equal to or less than the diameter of the combustion chamber.

6. The system as recited in claim 1, wherein the fuel deflector means includes at least a base that connects to a fuel injector, a fuel deflector standoff having a proximal end connected to the base, and a deflector member connected to the distal end of the deflector member.

7. The system as recited in claim 6, wherein the deflector member is disposed from the distal end of the deflector member at an angle to deflect fuel being injected in the combustion chamber from a fuel injector toward a centerline of the combustion chamber.

8. The system as recited in claim 7, wherein the deflector member includes being disposed from the distal end of the fuel deflector standoff at an angle between 20 degrees to 90 degrees.

9. The system as recited in claim 5, wherein the two or more hollow fuel injector receivers include being axisymmetrically spaced along the fuel rail assembly.

10. The system as recited in claim 1, wherein the ingress fuel port includes being connected to a pressurized fuel source.

11. The system as recited in claim 1, wherein the egress fuel port includes being connected to a pressure regulator.

12. The system as recited in claim 1, wherein the interior fuel passage of the fuel rail assembly includes being internally blocked between the ingress and egress fuel ports.

13. The system as recited in claim 1, wherein the fuel deflector means includes a nozzle.

14. The system as recited in claim 13, wherein a nozzle includes being disposed from an associated fuel injector into the combustion chamber and the nozzle is capable of causing the fuel being injected from the associated fuel injector being directed toward a centerline of the combustion chamber.

15. The system as recited in claim 14, wherein the nozzle includes being capable of directing the fuel being injected from the associated fuel injector toward the centerline of the combustion chamber at an angle between 20 degrees to 90 degrees.
